(19) United States
(12) Patent Application Publication
(10) Pub. No.: US 2026/0370178 A1
(43) Pub. Date: Nov. 19, 2026

(54) EQUIPMENT AND METHOD TO PRODUCE ELECTRIC ENERGY FROM VEHICLE HEADLIGHT

(71) Applicant: JPTUF OY, Kangasala (FI)

(72) Inventor: Jukka-Pekka TIUSANEN, Kangasala (FI)

(73) Assignee: JPTUF OY, Kangasala (FI)

(21) Appl. No.: 19/137,784

(22) PCT Filed: Dec. 12, 2023
(86) PCT No.: PCT/FI2023/050685

§ 371 Date: Jun. 11, 2025

(30) Foreign Application Priority Data
Dec. 13, 2022 (FI) 20226100

(51) Int. Cl. H02S 20/30; H02S 40/32

(52) U.S. Cl. CPC H02S 20/30; H02S 40/32

(57) ABSTRACT

An equipment to produce electric energy from vehicle headlight which equipment consists of at least one headlight to get light, at least one solar panel that has light cells to collect the light and to convert it into electric energy by a light electric phenomena and an inverter that has been connected to the mentioned solar panel to convert the produced DC power into AC power and where the solar panel has been located outside the vehicle in such a place in a common road where the light radiation of the headlight lamps of many into the same direction advancing vehicles has been adapted to hit the mentioned solar panel before each mentioned vehicle makes a sharp change of direction S or during it.

The object of this invention is equipment to produce electric energy from vehicle headlight which equipment consists of at least one headlight to get light, a solar panel with light cells to store the light energy and to convert into electric energy with the help of the light energy phenomenon and an inverter to convert the produced direct current into alternating current. The object of the invention is also the method to produce electric energy from vehicle headlight.

The intention of the invention is to gather largely the vehicles' headlight radiation energy and to convert it into direct current that then in turn can be converted with an inverter into alternating current and to be fed into the electric net.

The advantageous usages of the invention are heavy traffic ways of vehicles like cars and especially such locations where the headlight beams hit constantly in front of, alongside of, or upon the way situated solar panel. In other words, such driving way locations are advantageous from the point of view of the usage of the invention where the vehicles change direction. The sharper the change of direction is the more advantageous it is for the invention. On the other hand, the use of the invention is especially favorable in places where the vehicles use their high beams.

One way to take advantage from the invention is to locate solar panels in parking houses in such places where the vehicles turn from the driveway into a crossing driveway when the change of the direction is sharp near the solar panel. Another way to take advantage of the invention is to use it in twisty roads so that the solar panels are located in the turns in such a way that the light beams of the cars approaching the turn hit them before turning and/or when advancing in the turn. One from these different way to take advantage of the invention is to locate the solar panels on the hills in the roads above the road fixed for instance to the barriers above the roads.

The solutions according to the known technologies where the electric energy is produced from the vehicle headlights are based on methods to use the produced electricity in the vehicle itself. In these cases the solar panels or light cells are situated in the vehicle light lamps.

In the Korean patent publication KR20170014194A there is presented a vehicle headlight generator that consists of the headlight lamp 10, a solar panel 20 situated inside this lamp in its periphery area and an inverter to transfer the starting efficiency into the battery charging efficiency. In the solution of the publication the produced electric energy is used in the vehicle in question.

In another Korean patent publication KR20110033169A there has been presented as well a solution where the electric energy is produced in the vehicle headlight lamp. Even in this case all the equipments of the system are located in the vehicle and the produced electric energy is used in the vehicle where the lamp is situated.

The greatest disadvantages of the known technology in comparison of the invention are connected to the distributed production of the electric energy. Every headlight lamp needs an own inner headlight generator and every vehicle an own inverter and cablings between different equipments. The advantage comes to the holder of the vehicle but he also pays the additional equipment cost price. This distributed production according to the known technology is not useful for the general electricity net because it only produces electricity for the use of the own vehicle.

The intention of this invention is to achieve such an equipment and method to produce electric energy from the vehicle headlight that avoids disadvantages of the known technology. It is characteristic for the solution according to the invention that has been presented in the characterizing parts of the claims 1 and 5.

The greatest advantage of the invention in comparison to the known technology can be seen that the solutions according to it the light radiation energy from many vehicles can be transferred into an electric energy and connected efficiently and centralize its usefulness for instance in the general electricity net. A noteworthy advantage is achieved also that a lot greater amount of light energy than in the known technology per unit transferring equipment can be built more cost efficiently.

In this document entity the term “solar panel” means an equipment containing light cells that convert light energy into electric energy.

The invention is described in more detail in the enclosed drawings where

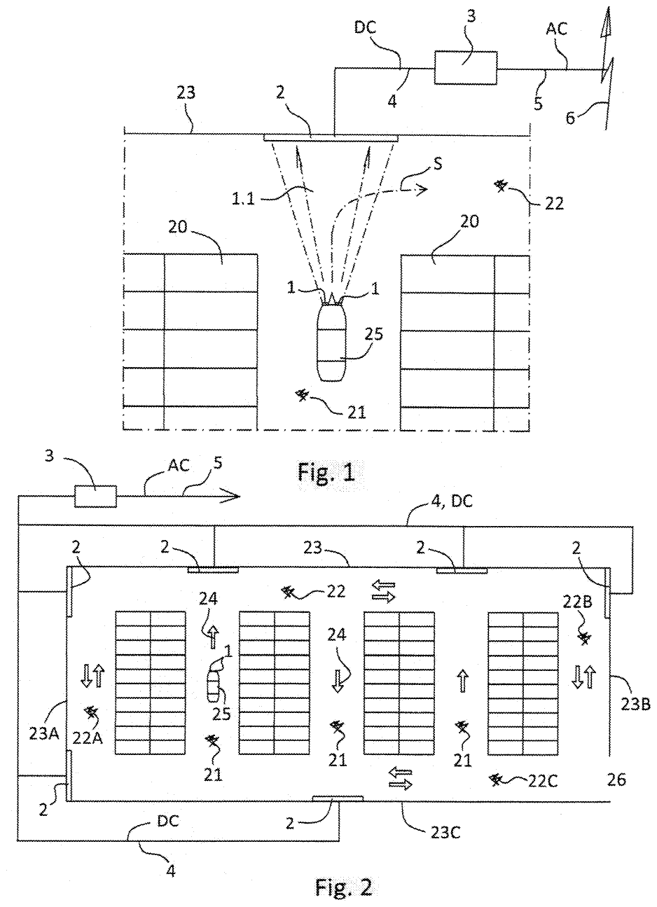

FIG. 1 presents an application of an equipment according to the invention located in a parking house,

FIG. 2 presents the before mentioned invention application in a larger scale,

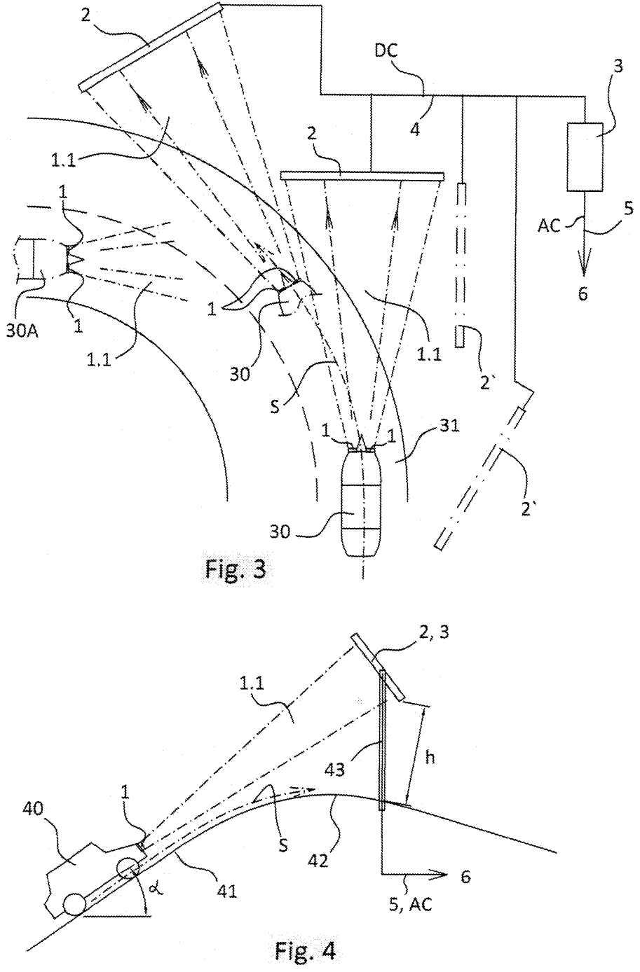

FIG. 3 presents an application where the equipment according to the invention is located in a road turn,

FIG. 4 presents an application where the equipment according to the invention is located on a hill in the road,

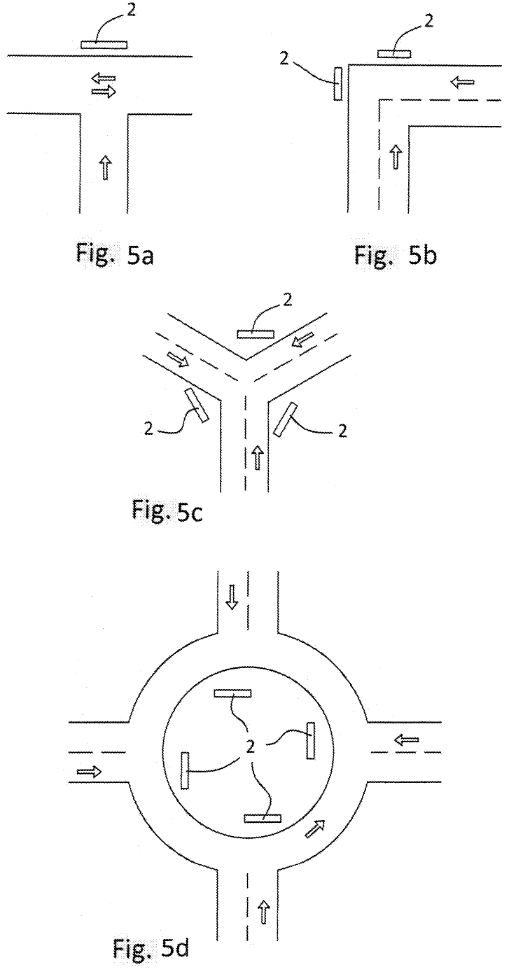

FIGS. 5a-5d present some for the invention favorable locations.

Next an Invention favorable application structure and operation is presented by referring to the before mentioned figures.

In the FIG. 1 there has been presented the floor plan of one part of a parking house. The driveway 21 between the parking squares 20 ends to the crossing driveway 22 that is situated beside the front wall 23 and the vehicle 25 approaches on the crossing driveway 22 in order to turn to it by making a sharp turn S. The “sharp turn” will be defined later. The vehicle headlights 1 are on and the light radiation 1.1 from them hits the solar panel 2 in the front wall 23 at the point of the driveway 22. The radiation energy of the headlight is converted in the light cells of the solar panel by a light electric phenomenon into electric energy. Thus created electric energy is DC power that is direct current that is converted in the method according to the invention into AC power that is alternating current with an inverter 3 that has been connected with the first cabling 4 to the solar panel 2. This way produced alternating current AC power can be fed through another cabling 5 into the electric net 6.

In the FIG. 2 there has been described more largely the parking house floor of the FIG. 1. In the floor there are three driveways 21 between the parking squares 20 and in addition to mentioned driveway 22 beside the front wall the driveways 22A, 228 beside the side walls 23A, 23B and the driveway 22C beside the back wall 23C. The driveways 21 between the parking squares are in this example one direction ways and beside the walls situated two way drive ways. In the front wall 23 and in the back wall 23C there has been located the solar panels 2 at the point of the drive ways 21 so that they are situated essentially in the front side of the vehicle 25 in the driving direction 24. In addition to this, the solar panels 2 have been adapted at the ends of the two way driveways 22A-22C exception being the in-drive and out-drive opening 26. Every solar panel 2 has been connected by the first cabling 4 into the inverter 3. Each solar panel 2 collects radiation energy from the headlight lamp 1 light beams 1.1 directed towards it and the equipment according to the invention converts it then first into DC power and after into AC power. If the driveways 21 are two way the solar panels 2 can be located at their both ends.

A parking house can contain one or more floors or areas equipped with the equipment according to the invention and one equipment can contain any desired number of solar panels 2 and one or more inverters 3.

In the FIG. 3 there has been presented another application of the invention. The vehicle 30 advances the road 31 towards a sharp turn and the light beams 1.1 of its headlight lamps 1 hit the outside the turn situated solar panel 2. When the vehicle 30 advances into the turn and makes a sharp change of the direction S its lights hit in order another solar panel 2. For the vehicle 30A coming from the opposite direction corresponding solar panels 2 taking advantage of its headlight can be adapted. There can be in this application of the invention any advantageous number of solar panels towards the driving direction and they can be adapted any size. Each solar panel 2 collects radiation energy from the lights of the headlight lamps 1 directed towards it and converts it into electric energy. Even in this application of the invention produced DC power is led through the first cabling 4 to the inverter 3 where it is converted into AC power and fed into electric net.

In the FIG. 4 a third application of the invention has been presented. A vehicle 40 approaches the top of a hill 42 in the road 41. The headlight lamps 1 of the vehicle point upwards an angle a above the horizontal level and the lights hit the solar panel 2 above the road before the car makes a sharp change S of direction and partly during it. The solar panel 2 has been located in a favorable position from the point of view of the operation of the equipment according to the invention using a beam 43. The light radiation 1.1 energy is converted in the solar panel into electric energy and further into AC power like in the previous example but the difference is that the inverter 3 has been integrated into the solar panel 2 so that only one outer cabling 5 is needed instead of two outer cablings that leads into electric net 6. The solar panel 2 should be installed in this application of the invention sufficiently high h from the surface of the road so that it does not hinder the traffic.

The before mentioned invention usage examples connected to the FIGS. 1 and 2 are very good when considered from the point of view of benefiting the invention because distances between the headlight lamps 1 and the solar panels 2 are short and especially just before the vehicle turns is the light radiation 1.1 from the headlight lamps 1 to the solar panels 2 is maximal efficient. In many countries there are regulations to use the headlight in the urban areas even in daytime and this adds the advantage of the invention.

The benefit of the applications of the invention in FIGS. 3 and 4 is also the greater the shorter the average distance between the headlight lamps 1 and the solar panels 2. In other words, the sharper change of direction of the driveway the more efficient is the light radiation 1.1 directed to the solar panel 2. In the road turn this efficiency is in relation to the sharpness of the turn and in the hill to the steepness of the slope.

Another benefit from the applications of the FIGS. 3 and 4 is obtained that in areas where there are not lights and is dark this kind of road areas can be driven using typically the high beam because the on-coming cars do not get dazzled at least because of the at least partly intersecting lanes. It is known that the high beams cause a more effective light radiation 1.1 that the low beams.

When comparing the application examples 1 and 2 of the invention with the examples 3 and 4 we can see that the before mentioned the advantage is taken more from the shorter distance between the headlight lamps 1 and the solar panels and in the latter one the greater power of the light radiation 1.1.

As can be seen what has been stated before the headlight lamps 1 in the equipment according to the invention are not permanent parts of the equipment but instead they change during the use of the invention when the headlight beams of different vehicles 25, 30, 30A, 40 hit the solar panels 2.

In the examples of the FIGS. 1 and 2 the solar panels 2 can reach for example 1.5 meters from the floor upwards and sidewise the width of the driveway. In the examples of the figures their width is more dependent upon the headlight lamp 1 and the solar panel 2 average distances from each other.

The vehicle 25 can be defined to make a sharp change of direction S that is advantageous from the point of the invention when advancing to the crossings T, L, Y, O of the FIGS. 5a-5d and to the driveway forking from them and when the vehicle 30, 30A, 40 changes direction during 30 meters at least 30°. The change of direction can be horizontal and/or vertical. The FIGS. 5a-5d are principle figures and are not binding situations for the application of the invention only to the angle relations of the crossing driveways.

So the present invention can be exploited both in urban and country side areas. Favorable places to use the invention are in addition to the mentioned parking houses, crossings, road turns, and hills are among others the motorway ramps, harbor driveways, lorry terminals, bus stations and like places where there is a heavy traffic.

The inverter can be adapted either in connection to every solar panel 2 or shared for a number of solar panels. When it is integrated into a solar panel 2 the first outer cabling 4 is not needed.

The electric net 6 can be a private, a local, or a national net. It can be of any size.

It should be noted that even though this explanation sticks to only one type for the invention favorable application example this will not limit in any way the use of the invention only for this kind example but many variations are possible as stated in the invention ideas of the claims.

1. Equipment to produce electric energy from the headlight of vehicle which equipment consists of at least one headlight to produce light, at least one solar panel having light cells to collect the light energy and to convert it into the electric energy by a light electric phenomenon and an inverter connected to the solar panel to convert the produced DC power into AC power and in which equipment the mentioned solar panel has been located outside the vehicle in a parking house, in a parking area, in a L- or T-crossing or in a roundabout wherein the solar panel/s has been situated in a parking house or in a parking area at the end of at least one crossing driveway shown by the driving direction, In the immediate continuation of the driveway of into the L crossing, or as the immediate continuation of the driveway ending in a T-crossing or a roundabout essentially in a vertical position so that at least a part of the light radiation of the headlight lamps in the space of the usage is directed to it/them perpendicularly and an essential part of them almost perpendicularly before the mentioned vehicle makes a sharp change of direction S in the mentioned crossing or roundabout, and which direction change is at least 85° and takes place essentially within the distance from the solar panel that corresponds the width of the crossing driveway.

2. The equipment according to the claim 1, wherein the solar panel/s has been adapted to reach upwards from the floor of the driveway about 1.5 meters above it.

3. The equipment according to the claim 1, wherein the solar panel/s have been adapted to be the driveway wide.

4. The equipment according to claim 1, wherein the solar panel has been connected to an inverter though an outer first cabling.

5. The equipment according to claim 1, wherein the inverter has been adapted in connection to the solar panel without an outer cabling between it and the solar panel.

6. The equipment according to claim 1, wherein it contains a second cabling to transfer the AC power from the inverter into the electric net.

7. The method to produce electric energy from vehicle headlight lamps in which method the equipment of some of claim 1 is used wherein it is performed as follows:
a. many vehicles are driven along the driveway of a parking house or area or into a T, L crossing or a roundabout in which case the light radiation of their headlight lamps is directed into the solar panel that is situated in front of the driveway vertically, and that the distance of the mentioned position location distance in front of which an abrupt at least 85° turn making mentioned vehicles correspond essentially the width of the crossing driveway.
b. the light radiation energy that is stored in the solar panel is converted there into DC power,
c. the caused DC power is converted by an inverter into the AC power,
d. the caused AC power is transferred with the second cabling into the electric net
